(19) United States
(12) Patent Application Publication
(10) Pub. No.: US 2024/0079803 A1
(43) Pub. Date: Mar. 7, 2024

(54) FLAT CABLE CONNECTOR

(71) Applicant: Aptiv Technologies (2) S.à r.l., Luxembourg (LU)

(72) Inventors: Duane Brantingham, Cortland, OH (US); Wesley W. Weber, Lapeer, MI (US); Jeffrey S. Campbell, West Bloomfield, MI (US)

(21) Appl. No.: 18/239,277

(22) Filed: Aug. 29, 2023

Related U.S. Application Data
(60) Provisional application No. 63/403,436, filed on Sep. 2, 2022.

(51) Int. Cl. H01R 12/59; H01R 12/77; H01R 13/422

(52) U.S. Cl. CPC H01R 12/592; H01R 12/771; H01R 13/422

(57) ABSTRACT

A connector assembly includes a connector housing. The connector housing includes a first side having a first opening. The first opening includes a first planar surface within the connector housing. The connector housing includes a second side having a second opening. The connector assembly includes a terminal with an attachment portion and a conductive member. The conductive member includes a tanged portion. The attachment portion includes a socket opening accessible through the second opening of the connector housing. The connector assembly includes a stuffer insertable into the first opening of the connector housing. The tanged portion of the terminal is engageable with the stuffer to urge the conductive member toward the first planar surface.

### CROSS-REFERENCE TO RELATED APPLICATION

This application claims benefit of priority to U.S. Provisional Patent Application No. 63/403,436 filed on Sep. 2, 2022, the entire disclosure of which is hereby incorporated by reference.

### BACKGROUND

The present disclosure relates generally to devices and methods for securing a flat cable to a conductive element. In general, electrically connecting a conductive element (i.e., a wire, cable, or other electrical conductor) to a flat cable may include an intermediate connection component such as a terminal. The electrical connection of a flat cable to a terminal may be unreliable and difficult to automate.

### SUMMARY

In some embodiments a connector assembly includes a connector housing. The connector housing includes a first side having a first opening. The first opening includes a first planar surface within the connector housing. The connector housing includes a second side having a second opening. The connector assembly includes a terminal with an attachment portion and a conductive member. The conductive member includes a tanged portion. The attachment portion includes a socket opening accessible through the second opening of the connector housing. The connector assembly includes a stuffer insertable into the first opening of the connector housing. The tanged portion of the terminal is engageable with the stuffer to urge the conductive member toward the first planar surface.

In some embodiments, a connector housing includes a first side having a first opening. A second side includes a plurality of second openings. A cavity extends between the first opening and the plurality of second openings. The cavity includes a first planar surface. A deflectable biasing member is located opposite from the first planar surface and biased to deflect toward the first planar surface. A plurality of apertures extends through the first planar surface of the connector housing.

In some embodiments, a method of securing a flat cable to a terminal includes providing a connector housing. The connector housing includes a first side having a first opening and a second side with a second opening. A connector housing body includes a cavity extending between the first opening and the second opening. An aperture extends through a bottom surface of the connector housing body. A welding element is provided. The terminal is inserted into the connector housing. The terminal includes a second conductive contact region. The flat cable is inserted into the connector housing. The flat cable includes a first conductive contact region. Mechanical contact is created between the first conductive contact region and the second conductive contact region. The first conductive contact region of the flat cable is welded to the second conductive contact region of the terminal through the aperture of the connector housing.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 illustrates an isometric view of a connector assembly for a flat cable, according to some embodiments.

FIG. 2 illustrates an exploded isometric view of a connector assembly for a flat cable, according to some embodiments.

FIG. 3 illustrates an exploded isometric view of a connector assembly housing and a plurality of terminals, according to some embodiments.

FIG. 4A illustrates an isometric view of a connector assembly housing and a plurality of terminals housed therein, according to some embodiments.

FIG. 4B illustrates a front view of a connector assembly housing and a plurality of terminals housed therein, according to some embodiments.

FIG. 5A illustrates an isometric sectional view of a connector assembly for a flat cable, according to some embodiments.

FIG. 5B illustrates a magnified isometric sectional view of the connector assembly of FIG. 5A, according to some embodiments.

FIG. 6A illustrates a top isometric view of a plurality of terminals secured to a flat cable, according to some embodiments.

FIG. 6B illustrates a bottom isometric view of a plurality of terminals secured to a flat cable, according to some embodiments.

FIG. 6C illustrates a top isometric view of a plurality of terminals having a leaf spring weld tab secured to a flat cable, according to some embodiments.

FIG. 7 illustrates a bottom isometric view of a connector housing assembly secured to a flat cable, according to some embodiments.

FIG. 8 illustrates an isometric sectional view of a connector housing assembly secured to a flat cable, according to some embodiments.

FIG. 9 illustrates a partially exploded isometric view of a connector housing assembly and a connector position assurance device, according to some embodiments.

FIG. 10 illustrates an exploded isometric view of a connector housing assembly including a mating device, according to some embodiments.

FIG. 11 illustrates a flow chart of a method of assembling a connector housing assembly with a flat cable, according to some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

According to some embodiments of this disclosure, an electrical connector assembly is provided, the electrical connector assembly including a connector housing, a terminal, a flat cable, and a stuffer. The electrical connector assembly is configured to electrically connect a conductive element (i.e., a wire, cable, or other electrical conductor) to the flat cable. The conductive element is electrically connected to the terminal, and the terminal is electrically connected to the flat cable, such that an electrical signal may travel from the conductive element, through the terminal, and to the flat cable (or vice-versa).

The electrical connection between the terminal and the flat cable may introduce problems in manufacturing the electrical connector assembly and may affect the durability of the electrical connector assembly. For instance, it may be difficult to reliably align the terminal with the conductive element of the flat cable. A lateral or longitudinal offset may reduce contact area between the terminal and flat cable, resulting in inefficient electrical conduction between the flat cable and the conductive element. In other cases, a pitch or roll offset (i.e., when two planar surfaces are non-parallel) may also reduce the contact area between the terminal and flat cable. The electrical connector assembly described herein describes various features, systems, and methods for creating intimate contact between the terminal and the flat cable.

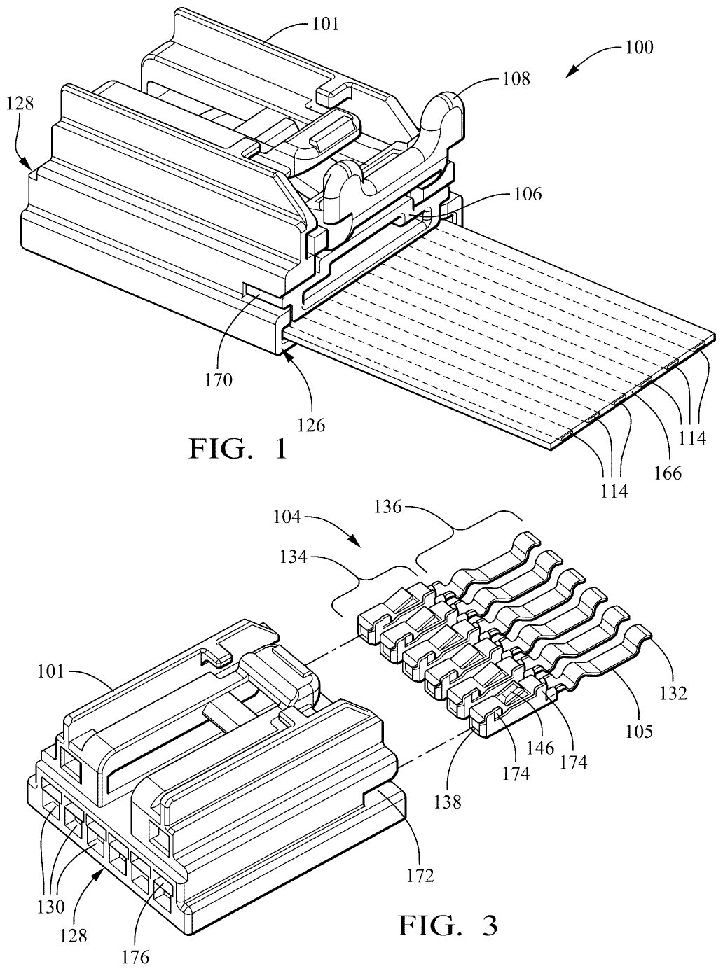

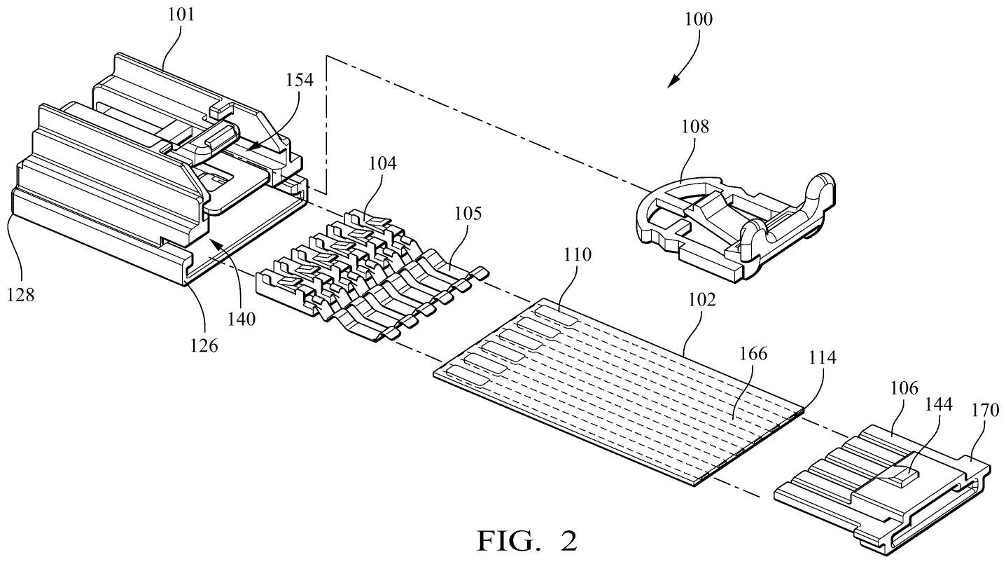

FIGS. 1-2 illustrate an isometric view and an exploded isometric view, respectively, of an electrical connector assembly 100, according to some embodiments. The electrical connector assembly 100 includes a connector housing 101 configured to receive a flat cable 102, a stuffer 106, and a connector position assurance (CPA) device 108 therein. The connector housing 101 may include a first end 126 and a second end 128 opposite from the first end 126. The flat cable 102 may include a flexible substrate 166 including flat conductive traces 114, e.g., thin copper strips, encased within an insulative material, such as polyethylene terephthalate (PET). Such a flat cable 102 is typically referred to as a flexible flat cable (FFC) or flexible printed circuit (FPC). According to some embodiments, the width of the conductive traces 114 may be varied to provide different electrical characteristics, e.g., resistance or current capacity. The insulative material may be removed from at least one end of the flat cable 102 to expose the conductive traces 114, thereby providing first conductive contact regions 110. Conductive material may be deposited over the conductive contact region(s) 110 to increase contact area between a conductive member 136 (e.g., as shown in FIG. 3) of the terminal 104 and the flat cable 102. In some embodiments, the first conductive contact regions 110 may include conductive weld tabs configured to be welded or soldered to the conductive member 136 of the terminal 104. In some embodiments, the conductive member 136 of the terminal may include conductive weld tabs (and/or second contact region 105) configured to be welded or soldered to the flat cable 102.

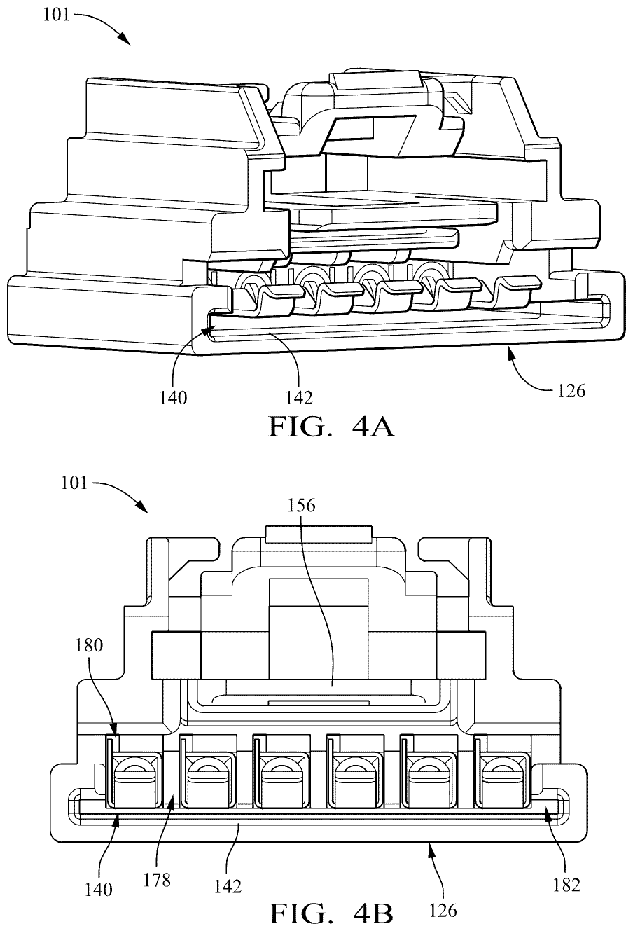

The terminal(s) 104, the flat cable 102, and the stuffer 106 are insertable into the connector housing 101 through a first opening 140 located on the first end 126 of the connector housing 101. The CPA device 108 may be inserted into the connector housing 101 at channel 154 located at the first end 126 of the connector housing 101. In some embodiments, the stuffer 106 may include one or more alignment wings 170 configured to be received within an outboard recess 172 at the first end 126 of the connector housing (see e.g., FIG. 4A). The mating of the alignment wing(s) 170 with the outboard recess 172 may ensure proper alignment/orientation of the stuffer 106 as the stuffer 106 is inserted into the connector housing 101.

In some embodiments, the connector housing 101 may include one or more features to ensure proper positioning of the terminal 104 seated within the connector housing 101. For instance, the connector housing 101 may include internal divider walls to ensure proper lateral position and orientation of the terminal 104 seated within the connector housing 101, and/or the connector housing 101 may include one or more alignment channels to receive one or more alignment tabs located on the terminal 104 to ensure proper positioning and alignment. In some embodiments, the connector housing 101 may include features/elements configured to ensure proper position of the flat cable 102 therein. For instance, the flat cable 102 may lay flush against a planar surface disposed within connector housing 101. In some embodiments, a ridge may run across the planar surface to provide a backstop for the flat cable 102, i.e., to ensure the flat cable is inserted into the correct depth of the connector housing. In some embodiments, the connector housing may include outboard channels to receive the lateral sides of the flat cable 102 therein to ensure proper lateral alignment and orientation of the flat cable 102 within the connector housing 101. Proper positioning of the flat cable 102 and the terminal 104 is important for ensuring intimate contact between the two components. For instance, a lateral or longitudinal offset may reduce contact area between the terminal 104 and flat cable 102, resulting in inefficient electrical conduction between the flat cable 102 and the conductive element. In other cases, a pitch or roll offset (i.e., when two planar surfaces are non-parallel) may also reduce the contact area between the terminal 104 and flat cable 102.

In some embodiments, the stuffer 106 may provide forward/rearward alignment of the terminal 104 within the connector housing 101. For instance, the stuffer 106 may abut the terminal 104 to urge the terminal 104 into a fully-seated position within the connector housing. In some embodiments, the stuffer 106 may abut the flat cable 102 to pinch the flat cable 102 against the planar surface 140 of the connector housing. The stuffer 106 may urge the terminal 104 toward the flat cable 102 to create intimate contact between the terminal 104 and the flat cable 102. In some embodiments, the stuffer 106 may provide lock assurance, as the locking detent 144 may engage the connector housing 101 to lock the stuffer 106 in-place.

In some embodiments, the CPA device 108 may be inserted into a channel 154 located on the connector housing 101. The CPA device 108 may provide lock assurance by forcing contact between the locking detent 144 and the connector housing 101 (i.e., preventing the locking detent 144 from disengaging the connector housing 101). In some embodiments, the CPA device 108 may provide connection assurance between the connector housing 101 and a mating device (see e.g., FIG. 10). For example, the connector housing 101 may be inserted into a mating device, and the CPA device may ensure the connector housing 101 in locked in place within the mating device.

FIG. 3 illustrates an isometric rear view of the connector housing and plurality of terminals, according to some embodiments. A second end 128 of the connector housing 101 may include one or more second opening(s) 130. The terminal 104 may include the conductive member 136 and an attachment portion 134. The conductive member 136 may include the second contact region 105 and a tanged portion 132 (i.e., a detent, tab, winged, or flared portion of the conductive member 136). The attachment portion 134 may include an opening 138 configured to receive a conductive element (e.g., a cable, wire, pin, etc.) therein. The attachment portion 134 may include one or more alignment tabs 174, a lock release aperture 176, and a deflectable connector lock 146.

As illustrated in FIG. 3, the electrical connector assembly may include a plurality of terminals 104 and a plurality of second openings 130. Each terminal 104 may be aligned with a second opening 130 and the attachment portion 134 of each terminal 104 may be positioned adjacent to a second opening 130. Thus, a conductive element (e.g., a cable, wire, pin, etc.) may be inserted through a second opening 130 and into an opening 138 of an attachment portion 134 of a terminal 104. In some embodiments, the lock release aperture 176 may be positioned adjacent to the second opening 130. The lock release aperture 176 may allow access to the deflectable connector lock 146, and in some cases, an unlocking member/tool (not illustrated) may be inserted into the lock release aperture 176 to urge the deflectable connector lock 146 toward the terminal 104. As the deflectable connector lock 146 is urged toward the terminal 104, the terminal 104 may be removed from the connector housing 101 through the first opening 140 (provided that the stuffer 106 and/or CPA 108 are also removed).

FIGS. 4A-B illustrate an isometric view and a front view of a connector housing 101 including a plurality of terminals 104 seated therein, according to some embodiments. The connector housing 101 includes a cavity formed between the first opening 140 and the second opening 130, wherein the cavity includes a planar surface 142 located adjacent the first end 126 of the connector housing 101. The cavity may include one or more divider walls 178 oriented perpendicular to the planar surface 142. The one or more divider walls 178 may be configured to space the terminals 104 from each other and provide alignment and/or orientation assurance for each of the terminals 104. In some embodiments, the cavity may include one or more alignment channels 180 to receive the alignment tabs 174 of the terminal 104. Mating of the alignment tab 174 within the alignment channel 180 may provide alignment and orientation assurance for the terminal 104. In some embodiments, the shape and/or size of the cavity may be configured to secure the stuffer 106 in place, for instance, by preventing lateral, horizontal, and/or vertical movement of the stuffer 106 within the cavity. The cavity may include an outboard channel 182 configured to receive the lateral edges of the flat cable 102 to provide alignment and orientation assurance for the flat cable 102 within the connector housing 101. Alignment and orientation assurance for the flat cable 102 and the terminal 104 is important for assuring proper alignment and connection between the first conductive region 110 on the flat cable 102 and the second conductive region 105 on the terminal 104.

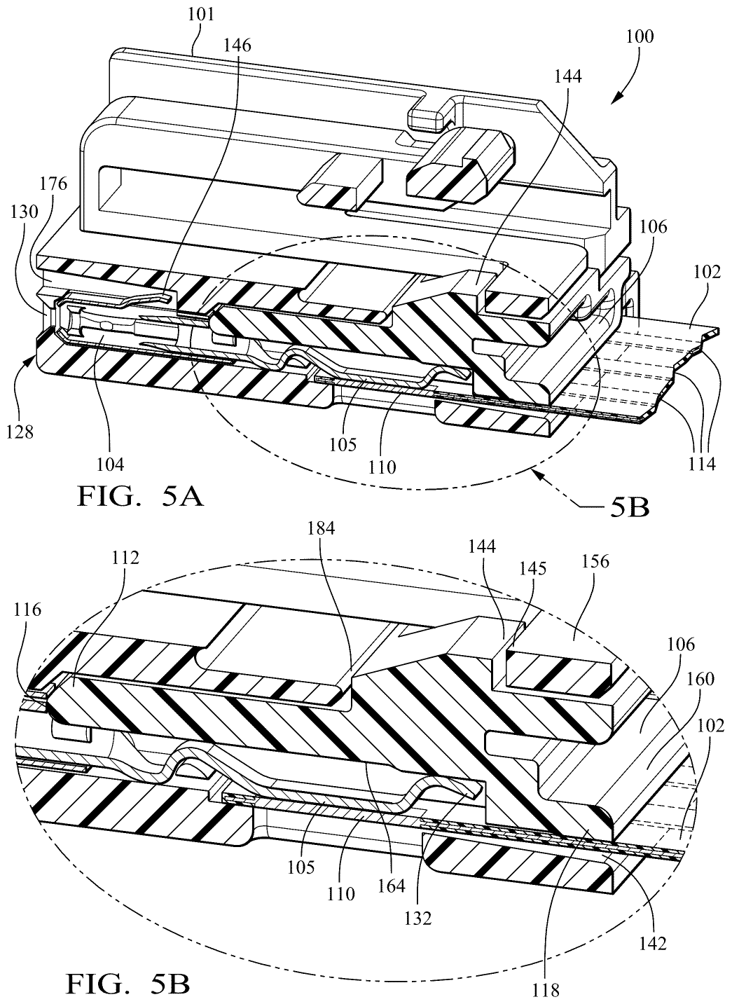

FIGS. 5A-B illustrate isometric sectional views of the electrical connector assembly with a flat cable, stuffer, and terminal installed therein, according to some embodiments. The flat cable 102 may be inserted through the first opening 140 and lay flush against the planar surface 142. The cavity may include a ridge 168 located on the planar surface 142, wherein the ridge acts as a backstop to prevent the flat cable 102 from being inserted too far into the connector housing 101. Thus, the ridge 168 may provide alignment and orientation assurance for the flat cable 102. In some embodiments, the attachment portion 134 of the terminal 104 is located adjacent to the ridge 168 and the conductive member 136 extends from the attachment portion 134 over the ridge 168 toward the first opening 140 of the connector housing 101. In some embodiments, the height of the ridge 168 may be approximately equal to the height of the flat cable 102.

In some embodiments, the stuffer 106 may include an elongate member 112 configured to engage and/or abut a surface 116 of the terminal 104. Thus, the stuffer 106 may urge the terminal 104 to be fully seated within the connector housing 101, providing orientation and alignment assurance. The stuffer 106 may include a locking detent 144 engageable with a locking surface 145 of the deflectable biasing member 156. The locking detent 144 may engage the locking surface 145 to lock the stuffer 106 in place, i.e., prevent the stuffer 106 from moving toward the first end 126 of the connector housing 101. The deflectable biasing member 156 may flex away from the planar surface 142 as the stuffer 106 is inserted into the connector housing 101, i.e., the locking detent 144 may urge the deflectable biasing member 156 as the stuffer 106 is slid into place. When the locking detent 144 passes by the locking surface 145 of the deflectable biasing member 156, the deflectable biasing member 156 may be biased to return toward the planar surface 142 (i.e., the deflectable biasing member 156 may be biased to deflect in a direction toward the planar surface 142). In some embodiments, the stuffer 106 may include a stop 184 configured to abut a surface in the connector housing 101 to prevent the stuffer 106 from moving toward the second end 128 of the connector housing 101, while in some embodiments, the contact between the elongate member 112 and the surface 116 of the terminal 104 prevents the stuffer 106 from moving toward the second end 128.

In some embodiments, the stuffer may include a ridge 160 configured to engage with the flat cable 102 in an area adjacent to the first end 126 of the connector housing 101. In some embodiments, the ridge 160 may provide a force against the flat cable 102 to pinch the flat cable 102 between the stuffer 106 and the planar surface 142. In some embodiments, the ridge 160 may include a second planar surface 118 to lay flush against the flat cable 102. The force between the stuffer 106 and the flat cable 102 may provide strain relief for the flat cable 102. In some embodiments, the force between the stuffer 106 and the flat cable 102 may provide connection assurance between the flat cable 102 and the terminal 104, as the flat cable 102 may be secured in-place by the pinch force between the stuffer 106 and the flat cable 102.

In some embodiments, the stuffer 106 may include an engagement surface 164 configured to engage the tanged portion 132 of the terminal 104. The engagement surface 164 of the stuffer 106 may urge the tanged portion 132 of the terminal 104 toward the flat cable 102. Thus, the conductive member 136 is forced against the flat cable 102, establishing an intimate connection between the conductive member 136 and the flat cable 102. In some embodiments, urging the conductive member 136 toward the flat cable 102 may increase a conductive contact area between the two components.

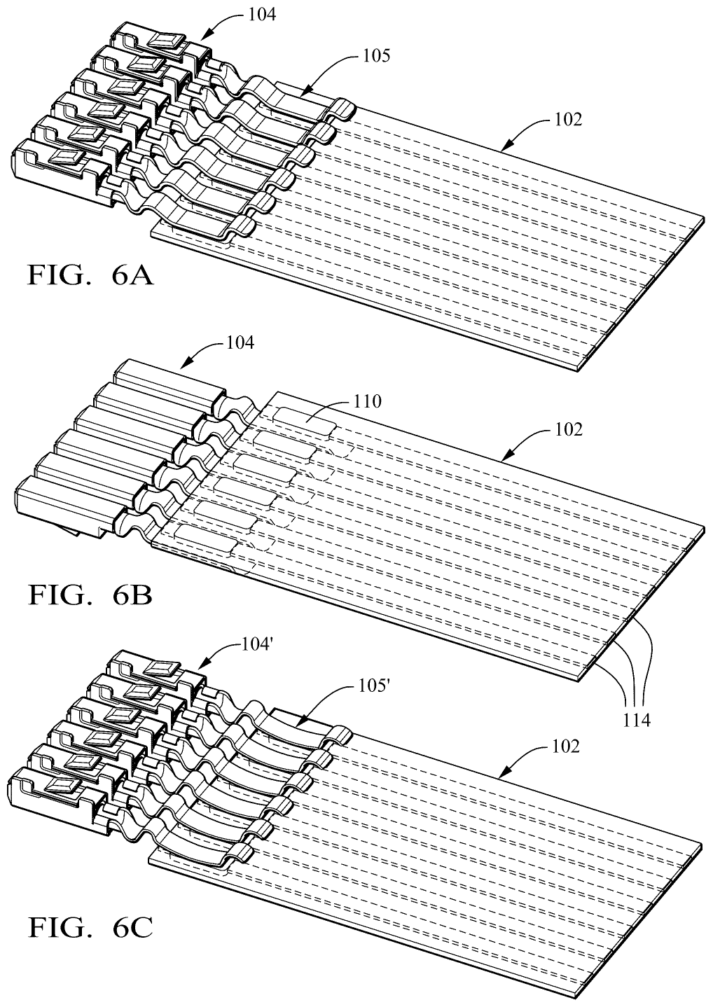

FIGS. 6A-C illustrate isometric top views and an isometric bottom view of a terminal to flat cable connection, according to some embodiments. In particular, FIGS. 6A and 6B illustrate a top view and a bottom view of the connection, respectively. FIG. 6C illustrates an isometric top view of a curved (or bowed) conductive contact region 105′ described in more detail below. FIGS. 6A and 6B show the first conductive contact regions 110 aligned with the second conductive contact regions 105. The second conductive contact regions 105 are substantially planar, and thus, contact the corresponding first conductive contact regions 110 along the entire length of the first conductive contact regions 110. In some embodiments, the conductive members 136 may be malleable, such that a downward force against the conductive member 136 may flatten the second conductive contact region 105. FIG. 6C illustrates an embodiment wherein a second conductive contact region 105′ is non-planar. Instead, the second conductive contact region 105′ is slightly curved. A downward force applied against the conductive member 136 (i.e., by the stuffer 106) may flatten the second conductive contact region 105′ against the first conductive contact region 110. In some embodiments, flattening the second conductive contact region 105′ against the first conductive contact region 110 may increase contact area and/or improve intimate contact between the two components, thereby improving the electrical connection.

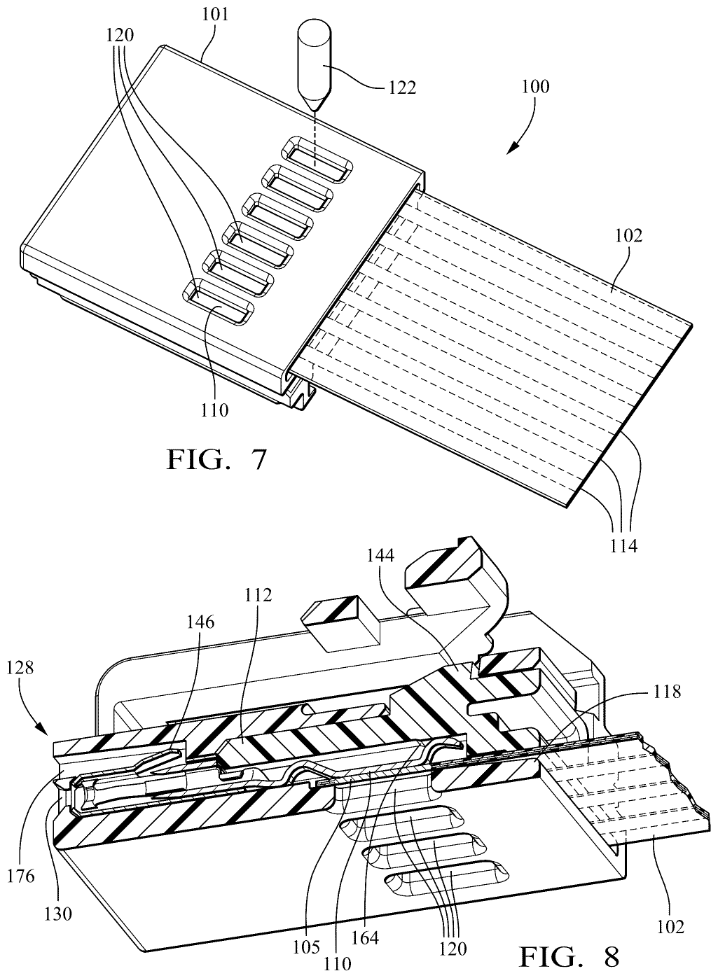

FIG. 7 illustrates a bottom isometric view of an electrical connector assembly, according to some embodiments. The connector housing 101 may include one or more aperture(s) 120. The apertures 120 may be aligned with the first conductive contact region 110 (and therefore aligned with the second conductive contact region 105). Therefore, because the first conductive contact region 110 is accessible through the aperture 120, a welding element 122 may weld the first conductive contact region 110 to the second conductive contact region 105 through the aperture 120. The welding element 122 may include a laser emitting device, an arc welding device, a solder iron, or any other welding device commonly known in the art.

The apertures 120 enable the flat cable 102 to be welded to the terminal 104 (or vice-versa) after the terminal 104 and flat cable 102 are inserted into the electrical connector assembly 100. Such configuration may be beneficial, as the insertion of the terminal 104, the flat cable 102, and the stuffer 106 may ensure intimate contact between the first conductive contact region 110 to the second conductive contact region 105 (see e.g., FIGS. 1-6C above, describing the stuffer 106 urging the terminal 104 toward the flat cable 102 to create intimate contact).

In some embodiments, the assembly process may be partially or entirely automated, i.e., the components may be secured together without human intervention. For example, the terminal 104 may be inserted through the first opening 140 of the connector housing 101 via a robotic implement. The alignment tabs 174 may ensure the proper alignment of the terminal 104 within the connector housing. The flat cable 102 may be inserted through the first opening 140 via a robotic implement. The ridge 168 and/or the outboard channel 182 may guide the flat cable 102 to the proper positioning within the connector housing 101 to ensure the first conductive contact region 105 is aligned with the second conductive contact region 110. After the flat cable 102 and the terminal 104 are inserted within the connector housing 101, the stuffer 106 may be inserted through the first opening 140 via a robotic implement. The mating of the outboard recess 172 and the alignment wing 170 of the stuffer 106 may guide the insertion of the stuffer 106 to the proper location within the connector housing 101. The stuffer 106 may urge the conductive member 136 of the terminal 104 toward the first conductive contact region 110 of the flat cable 102 to create intimate contact. In some embodiments, after intimate contact is created between the first conductive contact region 110 and the second conductive contact region 105, the welding element 122 may weld the first conductive contact region 110 to the second conductive contact region 105 through the aperture 120. In some embodiments, the welding element 122 may be automated. Thus, insertion of the terminal 104, the flat cable 102, and the stuffer 106 prior to welding the terminal 104 to the flat cable 102 may simplify the assembly process by providing built-in, intimate contact features for the first conductive contact region 110 and the second conductive contact region 105. If, for example, the terminal 104 was welded to the flat cable 102 prior to installation into the connector housing 101, additional steps may be required to guarantee intimate contact between the terminal 104 and the flat cable 102 prior to the welding step.

FIG. 8 illustrates an isometric sectional view of an electrical connector assembly, according to some embodiments. The connector housing 101 includes the plurality of apertures 120 disposed through the planar surface 142 to provide access to the first conductive contact region 110 of the flat cable 102. In other embodiments, the aperture 120 may provide access to the second conductive contact region 105 of the terminal 104. As illustrated in FIG. 8, the aperture 120 may be approximately the same size as the first conductive contact region 110 (i.e., approximately the same length and width). In some embodiments, the first conductive contact region 110 is approximately the same size as the second conductive contact region 105.

In some embodiments, the stuffer 106 may ensure that the terminal 104 is fully-seated within the connector housing 101, as the elongate member 112 urges the surface 116 of the terminal 104 toward the second end 128 of the connector housing 101. The stuffer 106 may contact the conductive member 136 of the terminal 104, and in some cases, the tanged portion 132 of the conductive member 136, to urge the conductive member 136 against the flat cable 102. The stuffer 106 may include the ridge 160 configured to engage the flat cable 102 and pinch the flat cable 102 between the ridge 160 and the planar surface 142.

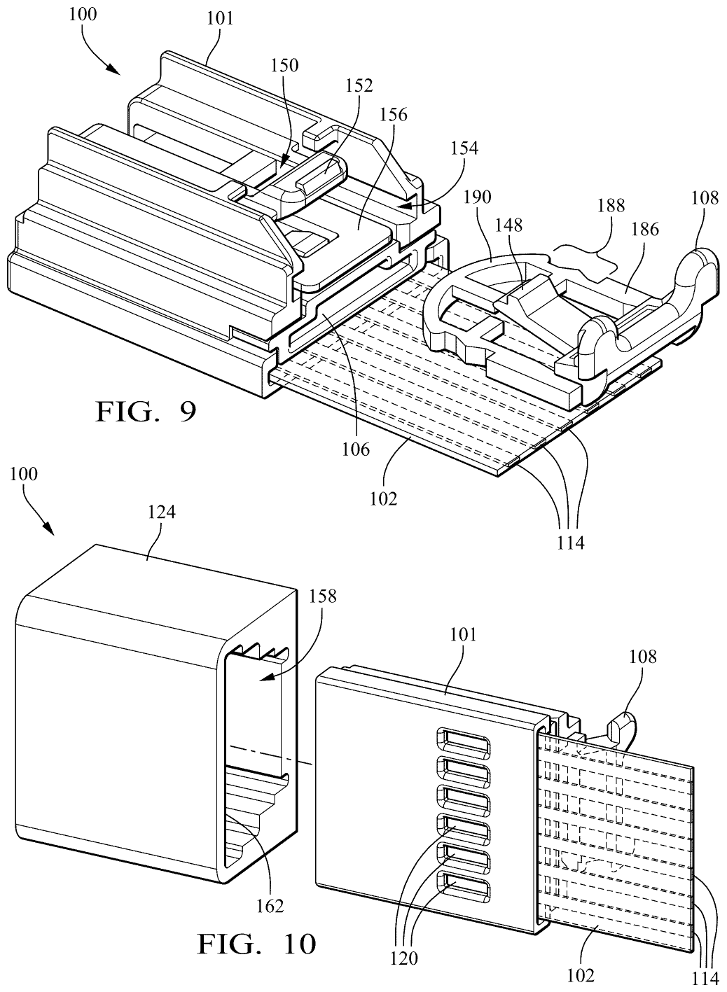

FIG. 9 illustrates an isometric view of an electrical connector assembly with a connector position assurance (CPA) device removed from the assembly, according to some embodiments. The CPA device 108 may include a locking tab 148. The locking tab 148 may be deflectable and biased to deflect in a first direction. The CPA device 108 may include outboard arms 186 having a locking surface 188. The locking surface 188 may include one or more detent(s) and/or recess(es) to engage with the connector housing 101. The CPA device 108 may include a deflectable bowed surface 190 configured to engage with the connector housing 101.

The connector housing 101 may include a channel 154 (i.e., a CPA channel) located at the first end 126 adjacent to the first opening 140. The channel 154 may be configured to receive the CPA device 108 therein and may provide an engagement surface to engage with the outboard arm 186, the locking surface 188, and/or the deflectable bowed surface 188. The connector housing 101 may include a locking recess 150 configured to receive the locking tab 148 therein, and selectively lock (or secure) the CPA device 108 to the connector housing 101. The connector housing 101 may include a deflectable release 152 configured to release the locking tab 148 from the locking recess 150. In some embodiments, the CPA device 108 may provide a tactile and/or auditory feedback when fully inserted into the connector housing 101.

The CPA device 108 may abut the deflectable biasing member 156, and in some embodiments, the CPA device 108 may prevent the biasing member 156 from deflecting away from the stuffer 106. Thus, the deflectable biasing member 156 including the locking surface 145 may be further secured by the CPA device 108, preventing the locking detent 144 of the stuffer 106 from disengaging the locking surface 145. In other words, the CPA device 108 may provide connection assurance for the stuffer 106, and since the stuffer provides connection assurance for the flat cable 102 and the terminal 104, the CPA device 108 thereby may provide connection assurance for the terminal 104 and the flat cable 102.

FIG. 10 illustrates an isometric view an electrical connector assembly and a mating device, according to some embodiments. The connector housing 101 may be inserted into opening 158 of mating device 124. The mating device 124 may include a planar surface 162 configured to slidingly receive the connector housing 101 and extend parallel to the planar surface 142 of the connector housing 101. In some embodiments, the mating device 124 may couple with the CPA device 108 to secure the connector housing 101 to the mating device. The mating device 124 may seal the connector housing 101 from wear, including liquid, moisture, dust, dirt, or other debris.

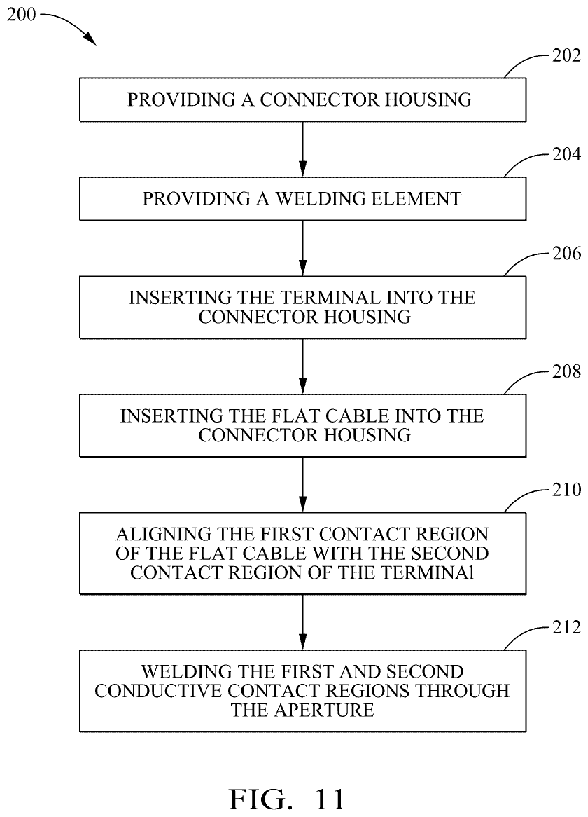

FIG. 11 illustrates a method of securing a flat cable to a terminal, according to some embodiments. At step 202, the method 200 may include providing a connector housing. The connector housing may include any and/or all features of the connector housing 101 described in any of FIGS. 1-10 above.

At step 204, the method 200 may include providing a welding element. The welding element may include a laser emitting device, an arc welding device, a solder iron, or any other welding device commonly known in the art. The welding element may include any and/or all features of the welding element 122 described in any of FIGS. 7-8 above.

At step 206, the method 200 may include inserting the terminal into the connector housing. The terminal may include any and/or all features of the terminal 104 (and the terminal 104′) described in any of FIGS. 1-10 above. The terminal 104 may be inserted through the first opening 140 of the connector housing 101. In some embodiments, the terminal 104 and the connector housing 101 may include one or more alignment features (e.g., the alignment tabs 174, the one or more divider walls 178, the alignment channel 180, etc.) configured to align the terminal 104 within the connector housing. The terminal 104 may be seated within the connector housing 101 such that the opening 138 of the attachment portion 134 may abut the second opening 130 at the second end 128 of the connector housing 101.

At step 208, the method 200 may include inserting the flat cable into the connector housing. The flat cable may include any and/or all features of the flat cable 102 described in any of FIGS. 1-10 above. The flat cable 102 may be inserted through the first opening 140 of the connector housing 101 and rest flush against the planar surface 142. In some embodiments, the connector housing 101 may include one or more alignment features (e.g., the ridge 168, the outboard channel 182, etc.) to ensure the proper positioning of the flat cable 102 with respect to the terminal 104.

At step 210, the method 200 may include creating a mechanical contact between a first conductive contact region of the flat cable and a second conductive contact region of the terminal. The first and second conductive contact regions may include any and/or all features of the first conductive contact region 110 and the second conductive contact region 105. In some embodiments, step 210 may include inserting a stuffer (e.g., the stuffer 106) through the first opening 140 of the connector housing 101. Inserting the stuffer 106 through the first opening 140 may mechanically deflect the second conductive contact region 105 of the terminal 104 toward the first conductive contact region 110 of the flat cable 102.

At step 212, the method 200 may include welding the first and second contact regions through an aperture. The aperture may include any and/or all features of the aperture 120 described in any of FIGS. 7-8 above. In some embodiments, the first and/or second conductive contact regions may be accessible through the aperture 120, and a laser or other welding element may weld/solder the first and second conductive contact regions together through the aperture 120.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A connector assembly, comprising:
a connector housing, including:
a first side including a first opening, the first opening including a first planar surface within the connector housing,
a second side including a second opening;
a terminal including a attachment portion and a conductive member, the conductive member including a tanged portion, and the attachment portion including a socket opening accessible through the second opening of the connector housing; and
a stuffer insertable into the first opening of the connector housing, wherein the tanged portion of the terminal is engageable with the stuffer to urge the conductive member toward the first planar surface.

2. The connector assembly of claim 1, further comprising:
a flat cable including a conductive trace and a first conductive contact region,
wherein the conductive member of the terminal includes a second conductive contact region.

3. The connector assembly of claim 2, wherein the connector housing includes an aperture disposed on the first planar surface and aligned with the first conductive contact region and the second conductive contact region, wherein one or more of the first conductive contact region and the second conductive contact region are accessible via the aperture.

4. The connector assembly of claim 1, wherein the flat cable is disposed between the stuffer and the first planar surface of the connector housing.

5. The connector assembly of claim 4, wherein the stuffer includes a ridge defining a second planar surface, wherein a portion of the flat cable located adjacent to the first side is disposed between the first planar surface and the second planar surface.

6. The connector assembly of claim 5, wherein a stuffer member of the stuffer abuts a first terminal surface of the attachment portion of the terminal and prevents the terminal from moving toward the first side of the connector housing.

7. The connector assembly of claim 6, wherein the stuffer includes a locking detent engageable with a locking surface of a deflectable biasing member of the connector housing.

8. The connector assembly of claim 1 further comprising a connector position assurance (CPA) device, the CPA device including a locking tab biased to deflect in a first direction and engage a locking recess in the connector housing.

9. The connector assembly of claim 8, wherein the locking tab of the CPA device provides one or more of a tactile feedback and an auditory feedback when the locking tab engages with the locking recess.

10. The connector assembly of claim 9, wherein the connector housing includes a channel located adjacent to the first opening, the CPA device insertable into the channel of the connector housing.

11. The connector assembly of claim 3, further comprising a mating device including an opening, wherein the connector housing is insertable into the opening, the mating device including a third planar surface configured to cover the aperture.

12. A connector housing, comprising:
a first side including a first opening;
a second side including a plurality of second openings;
a cavity extending between the first opening and the plurality of second openings, the cavity including a first planar surface;
a deflectable biasing member located opposite from the first planar surface and biased to deflect toward the first planar surface; and
a plurality of apertures extending through the first planar surface of the connector housing.

13. The connector housing of claim 12, wherein the first opening is configured to receive a flat cable and a stuffer, wherein the deflectable biasing member includes a locking surface engageable with a locking detent disposed on the stuffer to secure the stuffer within the connector housing.

14. The connector housing of claim 12, wherein the cavity includes a ridge along the first planar surface, wherein the plurality of apertures is located between the ridge and the first opening.

15. The connector housing of claim 12, wherein the first side includes a channel located adjacent to the first opening and located above the deflectable biasing member, wherein the channel is configured to receive a connector position assurance (CPA) device therein.

16. A method of securing a flat cable to a terminal, including:
providing a connector housing, including:
a first side including a first opening;
a second side including a second opening;
a connector housing body including a cavity extending between the first opening and the second opening, and
an aperture extending through a bottom surface of the connector housing body;
providing a welding element;
inserting the terminal into the connector housing, the terminal including a second conductive contact region;
inserting the flat cable into the connector housing, the flat cable including a first conductive contact region;
creating mechanical contact between the first conductive contact region and the second conductive contact region; and
welding the first conductive contact region of the flat cable to the second conductive contact region of the terminal through the aperture of the connector housing.

17. The method of claim 16, further comprising:
providing a stuffer; and
inserting the stuffer into the first opening of the connector housing, wherein insertion of the stuffer into the first opening urges the second conductive contact region of the terminal toward the first conductive contact region of the flat cable,
wherein the stuffer includes a ridge defining a second planar surface, wherein the ridge urges the flat cable toward the first planar surface and pinches the flat cable between the first planar surface and the second planar surface.

18. The method of claim 17, further comprising:
providing a connector position assurance (CPA) device including a locking tab biased to deflect in a first direction and a locking surface; and
inserting the CPA device into the first opening of the connector housing,
wherein the locking surface is engageable with the stuffer to prevent the stuffer from moving toward the first side of the connector housing.

19. The method of claim 18, wherein the locking tab of the CPA device provides one or more of a tactile feedback and an auditory feedback when the locking surface engages with the stuffer.

20. The method of claim 16, further comprising:
providing a mating device including an opening and a third planar surface; and
inserting the connector housing into the opening of the mating device, wherein the third planar surface covers the aperture of the connector housing.
